(19) United States
(12) Patent Application Publication
(10) Pub. No.: US 2014/0080466 A1
(43) Pub. Date: Mar. 20, 2014

(54) SMART PHONE CONTROL SYSTEM

(71) Applicant: Sheng-Yuan SHIH, Taipei City (TW)

(72) Inventor: Sheng-Yuan SHIH, Taipei City (TW)

(21) Appl. No.: 13/617,779

(22) Filed: Sep. 14, 2012

(51) Int. Cl. H04W 88/02

(52) U.S. Cl. 455/418

(57) ABSTRACT

A Smart Phone control system includes a Smart Phone device and a controlled device. The controlled device is an electronic device required to be set up by a user for the first time. The user uses the Smart Phone device to wired/wirelessly connect the controlled device. At this time, the Smart Phone device obtains a setup program stored in the controlled device to activate the setup program. The user uses the Smart Phone device to input the setup data, thereby setting up the controlled device for the first time. After the setup, the user ends the setup program to complete the first setup of the controlled device. When the program installed in the controlled device is to be updated, the Smart Phone device downloads the latest program and wired/wirelessly connect to the controlled device, thereby updating the controlled device.

### BACKGROUND OF THE INVENTION

a) Field of the Invention

The present invention relates to a Smart Phone control system, and in particular to a Smart Phone control system in which a Smart Phone device and a controlled device are wired/wirelessly connected to each other, so that a user can use the Smart Phone device to perform the first setup and update the programs necessary for the controlled device.

b) Description of the Prior Art

Nowadays, users like household electronic appliances to be used more conveniently. Further, the height and length of the household electronic appliances are restricted by the manufacturing apparatuses in this industry. As a result, controlling the household electronic appliances by wires is really not convenient in use and has restriction on space. Thus, control-by-wire cannot satisfy the requirements of modern people for work, home life, or leisure. Instead, remote control has been widely used in modern electronic appliances such as television, stereo device, air conditioner, car door or other industrial apparatuses.

According to the above, the television, stereo device or other household electronic appliances can be controlled in a remote manner. Further, with the rapid advancement of science and technology, various household electronic appliances are provided with intelligent control programs for intelligently controlling their operations, so that so-called “intelligent household appliances” are proposed. The intelligent control program not only can control the operation of household electronic appliances, but also can increase their efficiency in operation greatly.

However, the first use of the intelligent household appliance has to be connected with a computer. After the computer accesses the intelligent household appliance, the user can set up the intelligent household appliance via the computer by inputting a username, passwords or other control message. After the setup is completed, the household electronic appliance can be operated based on the control message.

Although the household electronic appliance can be set up and controlled by the above-mentioned method, the user has to connect the computer with the intelligent household appliance for the first setup, which is still inconvenient for the user.

Even, if the intelligent control program installed in the household electronic appliance needs to be updated, the user has to connect the household electronic appliance with the computer again. In this way, the computer can update the original intelligent control program, which is also inconvenient for the user.

Therefore, the present Inventor proposes a Smart Phone control system to solve the above problems based on his expert knowledge and deliberate researches.

### SUMMARY OF THE INVENTION

In order to solve the above problems, an objective of the present invention is to provide a Smart Phone control system, in which a Smart Phone device is wired/wirelessly connected to a controlled device to thereby access a control program installed in the controlled device. In this way, the user can input control data via the Smart Phone device to set up the controlled device for the first time, update firmware by program, and send control signal to destination (the controlled device).

Another objective of the present invention is to provide a Smart Phone control system, in which the Smart Phone device can download the update program necessary for the controlled device. Then, the Smart Phone device is wired/wirelessly connected to the controlled device to thereby update the controlled device.

In order to achieve the above objective, the present invention provides a Smart Phone control system including a Smart Phone device and a controlled device. The Smart Phone device comprises: a program storage unit for storing programs and data; a control unit for executing the programs stored in the program storage unit and providing transmission among the respective units; a data storage unit for receiving commands from the control unit and storing digital data; a display unit electrically connected to the control unit for receiving signals from the control unit and displaying an operating state of the Smart Phone device, the display unit being configured to allow a user to input commands or data by finger touch; a connecting interface electrically connected to the control unit and connected to the controlled device for sending the data of the Smart Phone device or receiving the data from the controlled device.

The controlled device comprises: a memory for storing programs and data; a processor for executing the programs and data stored in the memory; a transmission reception interface connected to the Smart Phone device for receiving and transmitting the data of the Smart Phone device; a control circuit electrically connected to the respective units for data transmission.

When in use, the user needs to perform the following steps:

In a first step, the connecting interface of the Smart Phone device is connected to the transmission reception interface of the controlled device, so that data transmission and reception can be carried out between the Smart Phone device and the controlled device. The data is stored in the data storage unit and the memory via the control unit and the processor.

In a second step, the Smart Phone device receives and stores a control program from the controlled device. The control program may be stored in the data storage unit and activated by the control unit. The control program after execution is displayed on the display unit, and then the whole system enters a user control mode.

In a third step, the user inputs control data via the display unit of the Smart Phone device. At this time, the controlled device also receives the control data inputted by the user, so that the user can set up the controlled device for the first time.

In a fourth step, after the user inputs the necessary data in the controlled device, the program is ended to disconnect the Smart Phone device from the controlled device, thereby achieving an input control effect.

### BRIEF DESCRIPTION OF THE DRAWINGS

FIG. 1 is a schematic view showing the Smart Phone device of the Smart Phone control system in accordance with the present invention;

FIG. 2 is a schematic view showing the controlled device of the Smart Phone control system in accordance with the present invention;

FIG. 3 is a flow chart showing the control procedure of the Smart Phone control system in accordance with the present invention; and

FIG. 4 is a flow chart showing a program updating procedure of the controlled device of the Smart Phone control system in accordance with the present invention.

### DETAILED DESCRIPTION OF THE INVENTION

The above objectives and structural and functional features of the present invention will be described in more detail with reference to preferred embodiment thereof shown in the accompanying drawings

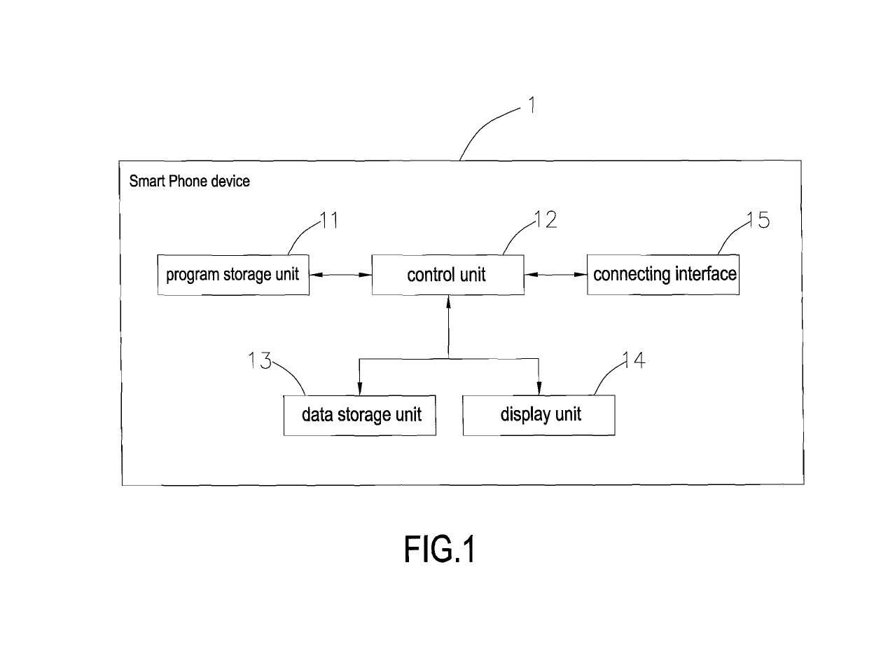

Please refer to FIG. 1, which is a schematic view showing the Smart Phone device of the Smart Phone control system in accordance with the present invention. The Smart Phone control system comprises a Smart Phone device 1 and a controlled device 2.

The Smart Phone device 1 comprises: a program storage unit 11, a control unit 12, a data storage unit 13, a display unit 14, and a connecting interface 15.

The program storage unit 11 is configured to store programs and data. Stored programs are to do initial setup process, updating firmware process and control process. The program storage unit 11 may be a flash memory or Electrically Erasable Programmable Read-Only Memory (EEPROM).

The control unit 12 may be a microprocessor, for example, a central processing unit (CPU), micro-controller (Micron), a Digital Signal Processor (DSP), Application Specific Integrated Circuit (ASIC), or a Programmable Logic Device (PLD) for executing the programs stored in the program storage unit 11 and providing transmission among the respective units.

The data storage unit 13 is configured to receive commands from the control unit 12 and storing digital data. The data storage unit 13 may be a hard disk or a solid state disk (SSD).

The display unit 14 is electrically connected to the control unit 12 for receiving signals from the control unit 12 and displaying an operating state of the Smart Phone device 1. The display unit 14 is configured to allow a user to input commands or data by finger touch. The display unit 14 may be a light emitting diode (LED) panel or a liquid crystal display (LCD) for displaying the operating state of the Smart Phone device 1.

The connecting interface 15 is electrically connected to the control unit 12 and wired/wirelessly connected to the controlled device 2 for sending the data of the Smart Phone device 1 or receiving the data from the controlled device 2. The connecting interface 15 may be electronic connectors, Bluetooth, Infrared or a wireless network.

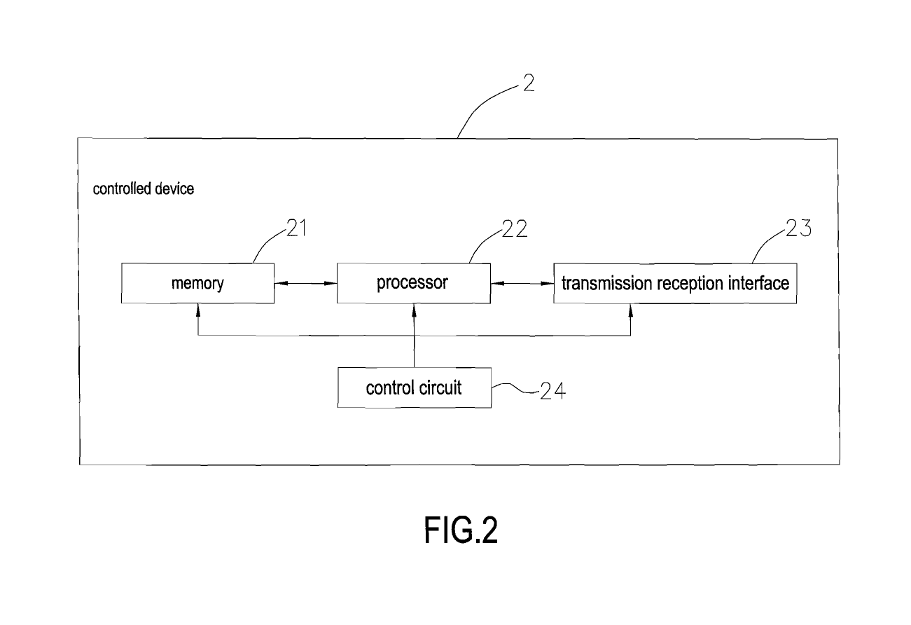

Please refer to FIG. 2, which is a schematic view showing the controlled device of the Smart Phone control system in accordance with the present invention. In the present invention, the controlled device 2 is an electronic device which has to be set up for the first time, such as a wireless router, an intelligent household appliance or the like.

The controlled device 2 comprises: a memory 21, a processor 22, a transmission reception interface 23, and a control circuit 24.

The memory 21 is configured to store programs and data.

The processor 22 is configured to execute the programs and data stored in the memory 21.

The transmission reception interface 23 is connected to the Smart Phone device 1 for receiving and transmitting the data of the Smart Phone device 1.

The control circuit 24 is electrically connected to the respective units for data transmission.

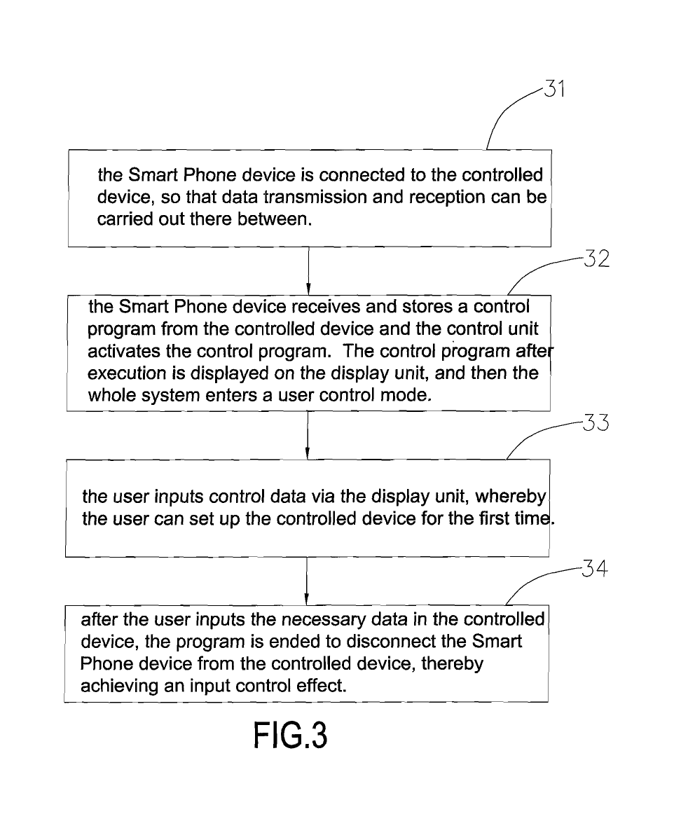

Please refer to FIG. 3, which is a flow chart showing the control procedure of the Smart Phone control system in accordance with the present invention. The control procedure of the Smart Phone device and the controlled device includes the following steps.

In a first step 31, the connecting interface 15 of the Smart Phone device 1 is connected to the transmission reception interface 23 of the controlled device 2, so that data transmission and reception can be carried out between the Smart Phone device 1 and the controlled device 2. The data is stored in the data storage unit 13 and the memory 21 via the control unit 12 and the processor 22.

In a second step 32, the Smart Phone device 1 receives and stores a control program from the controlled device 2. The control program may be stored in the data storage unit 13 and activated by the control unit 12. The control program after execution is displayed on the display unit 14, and then the whole system enters a user control mode. Above processes are initial setup processes.

In a third step 33, the user inputs control data via the display unit 14 of the Smart Phone device 1. At this time, the controlled device 2 also receives the control data inputted by the user, so that the user can set up the controlled device 2 for the first time.

In a fourth step 34, after the user inputs the necessary data in the controlled device 2, the program is ended to disconnect the Smart Phone device 1 from the controlled device 2, thereby achieving an input control effect.

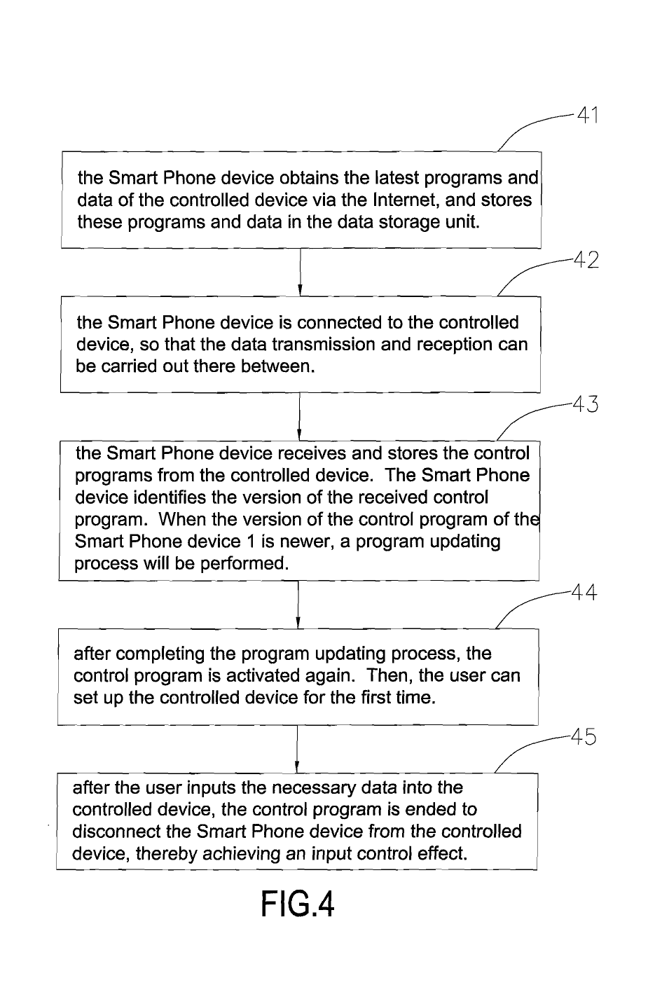

Please refer to FIG. 4, which is a flow chart showing a program updating procedure of the controlled device of the Smart Phone control system in accordance with the present invention. The program updating procedure includes the following steps.

In a first step 41, the user uses the Smart Phone device 1 to obtain the latest programs and data of the controlled device 2 via the Internet (ex. Updated firmware of controlled device), and stores these programs and data in the data storage unit 13.

In a second step 42, the connecting interface 15 of the Smart Phone device 1 is connected to the transmission reception interface 23 of the controlled device 2, so that the data transmission and reception can be carried out between the Smart Phone device 1 and the controlled device 2. The data can be stored in the data storage unit 13 and the memory 21 via the control unit 12 and the processor 22.

In a third step 43, the Smart Phone device 1 receives and stores the control programs from the controlled device 2. The control programs may be stored in the data storage unit 13. At this time, the Smart Phone device 1 identifies the version of the received control program. When the version of the control program of the Smart Phone device 1 is newer than the version of the controlled device 2, the control unit 12 of the Smart Phone device 1 can activate the newer version of the control program to thereby perform a program updating process.

In a fourth step 44, after completing the program updating process, the control program is activated again. Then, the user can set up the controlled device 2 for the first time.

In a fifth step 45, after the user inputs the necessary data into the controlled device 2, the control program is ended to disconnect the Smart Phone device 1 from the controlled device 2, thereby achieving an input control effect.

After the above initial process finished, the Smart phone device and the controlled device established an one to one pairing relationship. Thus users is able to control or manipulate targeted device. For example, user can control the smart home appliances through an app program installed on the Smart phone. Thus user can adjust temperature or check the status on the home appliances.

In order to make the Examiner to better understand the first setup of the controlled device, a preferred embodiment thereof will be described as follows. For example, the controlled device may be a wireless router currently available in the market. After the user buys the wireless router, the wireless router has to be connected to a computer first. The computer accesses the wireless router to activate the control program. Then, the user can input a username and passwords of Internet and other settings (even a fire wall) into the control program. After the setup is completed, the user needs not to set up for the second time, and the user can access the Internet directly via the wireless router. The activation of the control program and the input of a username and passwords can be considered as the first setup of the wireless router.

According to the present invention, the connecting interface of the Smart Phone device is connected to the wireless router, thereby obtaining and activating the control program of the wireless router. The user uses the wireless router to input a username and passwords. After inputting the username and the passwords, the first setup is completed. In this way, it is not necessary to use any computer and wired connection, so that the present invention can be widely used in intelligent electronic appliances.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A Smart Phone control system, including:
a Smart Phone device comprising: a program storage unit for storing programs and data; a control unit for executing the programs stored in the program storage unit and providing transmission among respective units; a data storage unit for receiving commands from the control unit and storing digital data; a display unit electrically connected to the control unit for receiving signals from the control unit and displaying an operating state of the Smart Phone device, the display unit being configured to allow a user to input commands or data by a finger touch; and a connecting interface electrically connected to the control unit for providing a connection of wired/wireless signals; and
a controlled device comprising: a memory for storing programs and data; a processor for executing the programs and data stored in the memory; a transmission reception interface connected to the Smart Phone device for receiving and transmitting the data of the Smart Phone device; and a control circuit electrically connected to the respective units;
whereby, the connecting interface of the Smart Phone device is connected to the transmission reception interface of the controlled device, the Smart Phone device obtains a setup program stored in the controlled device and stores the setup program in the data storage unit for activation, a user uses the Smart Phone device to input setup data as a first setup for the controlled device, the user ends the setup program after the setup, thereby achieving the first setup of the controlled device.

2. The Smart Phone control system according to claim 1, wherein the program storage unit is a flash memory or an Electrically Erasable Programmable Read-Only Memory (EEPROM).

3. The Smart Phone control system according to claim 1, wherein the control unit is a microprocessor, for example, a central processing unit (CPU), micro-controller (Micron), Digital Signal Processor (DSP), Application Specific Integrated Circuit (ASIC), or Programmable Logic Device (PLD).

4. The Smart Phone control system according to claim 1, wherein the data storage unit is a hard disk or a solid state disk.

5. The Smart Phone control system according to claim 1, wherein the display unit is a light-emitting diode (LED) or a liquid crystal display (LCD).

6. The Smart Phone control system according to claim 1, wherein the connecting interface is electronic connector, Bluetooth, Infrared or a wireless network.

7. The Smart Phone control system according to claim 1, wherein the program storage unit can not only preserve program for first time setup but also other programs like control or manipulate the controlled system.

8. A Smart Phone control system, including:
a Smart Phone device comprising: a program storage unit for storing programs and data; a control unit for executing the programs stored in the program storage unit and providing transmission among respective units; a data storage unit for receiving commands from the control unit and storing digital data; a display unit electrically connected to the control unit for receiving signals from the control unit and displaying an operating state of the Smart Phone device, the display unit being configured to allow a user to input commands or data by a finger touch; a connecting interface electrically connected to the control unit for providing a connection of wired/wireless signals; and
a controlled device comprising: a memory for storing programs and data; a processor for executing the programs and data stored in the memory; a transmission reception interface connected to the Smart Phone device for receiving and transmitting the data of the Smart Phone device; and a control circuit electrically connected to the respective units;
whereby, when the program stored in the controlled device is to be updated, the user uses the Smart Phone device to obtain the latest programs and data of the controlled device via the Internet, the connecting interface of the Smart Phone device is connected to the controlled device to receive the control program in the controlled device, the Smart Phone device identifies a version of a received control program, the control unit of the Smart Phone device activates a newer version of the control program, thereby performing a program updating process if the version of the control program of the Smart Phone device is newer than the version of the controlled device.

9. The Smart Phone control system according to claim 8, wherein the program storage unit is a flash memory or an Electrically Erasable Programmable Read-Only Memory (EEPROM).

10. The Smart Phone control system according to claim 8, wherein the control unit is a microprocessor, for example, a central processing unit (CPU), micro-controller (Micron), Digital Signal Processor (DSP), Application Specific Integrated Circuit (ASIC), or Programmable Logic Device (PLD).

11. The Smart Phone control system according to claim 8, wherein the data storage unit is a hard disk or a solid state disk.

12. The Smart Phone control system according to claim 8, wherein the display unit is a light-emitting diode (LED) or a liquid crystal display (LCD).

13. The Smart Phone control system according to claim 8, wherein the connecting interface is electronic connector, Bluetooth, Infrared or a wireless network.
